(19) United States
(12) Patent Application Publication
(10) Pub. No.: US 2026/0339616 A1
(43) Pub. Date: Oct. 29, 2026

(54) System and Method for a Fragmented Persistence Object Services Model

(71) Applicant: Harman Solutions LLC, Chula Vista, CA (US)

(72) Inventor: John T. Harman, Chula Vista, CA (US)

(21) Appl. No.: 19/662,998

(22) Filed: Apr. 29, 2026

Related U.S. Application Data
(60) Provisional application No. 63/796,849, filed on Apr. 29, 2025.

(51) Int. Cl. G06F 8/20

(52) U.S. Cl. CPC G06F 8/20

(57) ABSTRACT

A Fragmented Persistence Object Services (FPOS) system and method for databases, converting multiple data types into an object-based framework, enabling enhanced data tracking and management. A Logical Object Configuration module abstracts different input data types from a Microservice into objects categorized as Logical System Object Type, a Logical Relationship Type and a Logical Data Type. The different data types being input from at least one or more databases, wherein the objects are further categorized into categories of Entity or an Operation. A Data Fragmentation module fragments the Entity and Operation objects in coordination with a Global Configuration data structure into a Multi-type Data Storage Ensemble containing different database types, enabling the different input data types to be matched to respective database types. The FPOS system and method therefore enables optimized storage, search, reconstruction, retrieval, tracking and scalability of information of different data types.

### CROSS-REFERENCE TO RELATED APPLICATION(S)

This application claims the benefit and priority of U.S. Provisional Patent Application No. 63/796,849, filed Apr. 29, 2025, the contents of which are hereby incorporated by reference in its entirety.

### FIELD OF INVENTION

This invention is directed to the field of “object”-to-software correlation and management. More specifically, a software design architectural pattern is provided which can manage data for any “thing” or “activity” with exact specification through a highly configurable model so that software applications can be built and operate more efficiently and represent the subject matter of the software with exactness.

### BACKGROUND

Existing commercial software systems which capture and store data for business operations including biopharmaceutical, health, energy, transportation, defense, education and many others are built upon a single database technology. Software architectures are evolving from singular one large application and database for data storage (“monoliths”) to integrated small task-based “microservices” each with their own single database to improve security, scalability and shift to global cloud-based software. Each system uses one database technology to store information about the actions of objects those software systems are meant to manage as digital records through user interfaces or automated compute services. Forcing actions and objects into a single data storage type means that each database is bespoke for only a specific use case and will perform poorly in certain aspects of data management if not excluding key information altogether.

In view of the above, there has been a long standing need in the industry for a more flexible software-database model, that is not constrained by data types and matching data type supporting databases. Various systems and methods for a Fragmented Persistence Object Services model is described, addressing the above short-comings in the prior art.

### SUMMARY OF INVENTION

The Fragmented Persistence Object Services (FPOS) model is described in this disclosure in the context of a cloud native software architectural pattern which includes a specific set of database types used in a specific way to facilitate the complete and accurate definition and persistent storage of any theoretical or physical action or object as a digital record. The FPOS includes core technology components and services which facilitate the definition and storage of any “thing” or “action” in as little or much detail as desired for representation of the physical or theoretical world as data. The architectural pattern is data type agnostic and capable of tracking and managing any object we can define today, as well and can be expanded using the same pattern to include and adopt any future network, compute, or database technologies. The FPOS model demonstrated below is presented for demonstration purposes in the context of Object-centric microservices which service and interact with various databases, and includes tactics for development and deployment of software systems using the FPOS model in multiple commercial and regulatory environments. While the above presents an introductory explanation of some features of the invention, other features are also detailed in various embodiments.

For example, in one aspect of the disclosed embodiments, a Fragmented Persistence Object Services (FPOS) system for databases, converting multiple data types into an object-based framework, enabling enhanced data tracking and management is provided, comprising: a Logical Object Configuration module abstracting different input data types through a Microservice into objects categorized as Logical System Object Type, a Logical Relationship Type and a Logical Data Type, the different data types being input from at least one or more databases, wherein the objects are further categorized into categories of Entity or an Operation; and a Data Fragmentation module fragmenting the Entity and Operation objects in coordination with a Global Configuration data structure into a Multi-type Data Storage Ensemble containing different database types, enabling the different input data types to be matched to respective database types, wherein the FPOS system enables optimized storage, search, reconstruction, retrieval, tracking and scalability of the different input data types.

In another aspect of the disclosed embodiments, the above system is provided, wherein the Microservice is an Object-centric Microservice and a fragment identifier assigned by the Object-centric Microservice during a write operation for different input data types persists into both the Multi-type Data Storage Ensemble used for transactional operations and a separate analytics data store, such that an analytics consumer accesses fragmented data using the same fragment identifier without an intermediate extract-to-transform-to-load process; and/or wherein a chronological storage component associated with a transaction is implemented as one of: (i) a dedicated time-series database, and (ii) an event-streaming data lake comprising event ingestion, stream processing and delivery, persistent storage, data cataloging, and analytical query stages; and/or further comprising: a relational database storing attribute values and operation result values; graph database storing object relationships; an object store storing file attachments; at least one of a time series and event series database storing history and logging information; and a NoSQL database storing configuration data, wherein data stored in the various databases are utilized by the Data Fragmentation module to enable efficient data type-to-object-to-database type fragmentation; and/or further comprising a plurality of graph databases containing relationships of objects, wherein data about the object is fragmented and is stored in different database types corresponding to at least one of a characteristic of the fragment and to a data type of the fragment; and/or further comprising fragmentation identifiers, which map an object for at least one of storage and retrieval, to a matching database type, wherein one or more of the fragmentation identifiers contain an Object Definition ID, an Attribute Definition ID, an Identifier Definition ID, an Attribute Value ID, and a Result Value ID; and/or further comprising one or more Object-centric Microservices facilitating the different data types being input and the fragmentation and re-assembly of data records across the different database types, for the objects categorized through the Logical Object Configuration module and a Local System Instance copy of the Global Configuration data structure; and/or wherein the Logical System Object Type, the Logical Relationship Type and the Logical Data Type are created in a Local System Instance and contained in a Global Manage System, wherein the Logical System Object Type, the Logical Relationship Type and the Logical Data Type contain type definitions across system version releases; and/or wherein a Logical System Object is formed from the Logical Relationship Type and the Logical Data Type, wherein the Entity includes multiple Entity Classes having defined Attributes and Logical Relationship Types; and/or wherein the Attributes are derived from the Logical Data Type and Relationships are obtained from the Logical Relationship Type; and/or wherein each Entity Class is formed from the Attributes and Logical Relationship Types; and/or further comprising a plurality of database tables containing an Object Class corresponding to object classes impacting navigation and organizational rules, an Operation Result Definition corresponding to operation result definitions, an Identifier Sequence Definition corresponding to identifier sequence definitions enabling at least one of human meaning and barcode generation, an Object Definition corresponding to object definitions implemented and managed by relevant organizations, an Object Definition Version corresponding to changes in an object definition for system version releases persistence, an Object Version corresponding to tracking object changes within system version releases, an Attribute Definition corresponding to object attribute definitions, and a Value_Unit corresponding to equivalences across different measurement units; and/or further comprising an Object-centric Microservices managing the Entity Classes; and/or wherein a first object identified as a first Entity is related to another object identified as a second Entity via the Relationships; and/or wherein the Multi-type Data Storage Ensemble is deployed in a private instance corresponding to an organizational user, and wherein the Logical Object Configuration is replicated from a global configuration store managed by a software provider distinct from the organizational user.

In yet another aspect of the disclosed embodiments, a method to process information in a database by converting multiple data types into an object-based framework, enabling enhanced data tracking and management is provided, comprising: abstracting different data types into objects as a Logical System Object Type, a Logical Relationship Type and a Logical Data Type; categorizing the objects into compute service categories of an Entity or an Operation; creating a Local System Instance, wherein a Global Configuration data structure tracks the abstraction results; and fragmenting the Entity and Operation and System objects in coordination with the Global Configuration data structure into a Multi-type Data Storage Ensemble containing different database types, wherein the Multi-type Data Storage Ensemble enables the different input data types to be matched to respective database types, wherein the method enables rapid storage, search, reconstruction, retrieval, tracking and scalability.

In still another aspect of the disclosed embodiments, the above method is provided, further comprising: storing attribute information and operation result information in a relational database; storing object relationships information in a graph database; storing file attachments information in an object store; storing history and logging information in at least one of a time series and event series database; storing configuration information in a NoSQL database; and fragmenting information on the objects according to the stored information; and/or further comprising, assigning relationships between objects via a plurality of graph databases, wherein data about the object is split into fragments, wherein each fragment is stored in a database type corresponding to at least one of a characteristic of the fragment and a data type of the fragment; and/or further comprising, inputting data, managing data transactions, fragmentation and re-assembly of data records across different database types via one or more Object-centric Microservices, utilizing the Global Configuration data structure.

In another aspect of the disclosed embodiments, a data type agnostic, database management method, utilizing abstractions of data to distribute computation object services is provided, comprising: servicing one or more databases having information of different data types; reading the information from the one or more databases; assigning a Location to the information having a physical location; categorizing the information into objects having a Logical System Object Type, a Logical Relationship Type and a Logical Data Type; creating a NoSQL database type containing mappings of the read information to the categorized objects, wherein the NoSQL database is modifiable and configurable without requiring new coding instructions to be written; and fragmenting the information via its object categorization and mapping fragmented information into a Multi-type Data Storage Ensemble containing non-similar database types, wherein the fragmenting and Multi-type Data Storage Ensemble enables efficient information storage, search, reconstruction, retrieval, tracking and scalability.

In yet another aspect of the disclosed embodiments, the above method is provided, further comprising: storing and retrieving relationships between objects via Graph databases; and using the Graph databases to split data about the object into fragments, wherein each fragment is stored in the Multi-type Data Storage Ensemble; and/or further comprising: storing information on the objects in a combination of a relational database, graph database, object store, time series or event series databases and NoSQL databases; and/or further comprising, communicating information in the one or more databases through an Object-centric Microservices and an institutional user via a Cloud-network; and/or further comprising, performing an inheritance hierarchy from a Logical System Object to an Entity Class to an Entity Definition to an Entity Record, wherein the inheritance hierarchy facilitates the no new coding instructions requirement; and/or further comprising: forming different versions via a plurality of local instances, wherein a Logical Object Configuration containing the Logical System Object Type, the Logical Relationship Type and the Logical Data Type is replicated from a global configuration to provide a version-coupled configuration according to a global-to-local replication.

In another aspect of the disclosed embodiments, a non-transitory computer-readable medium storing instructions which, when executed by one or more processors, cause the one or more processors to perform operations is provided, comprising: abstracting information from different data types into objects as a Logical System Object Type, a Logical Relationship Type and a Logical Data Type; categorizing the objects into compute service categories of an Entity or an Operation; creating a Local System Instance, wherein a Global Configuration data structure tracks results of the abstraction; and fragmenting the Entity and Operation objects in coordination with the Global Configuration data structure into a Multi-type Data Storage Ensemble containing different database types, wherein the different data types are matched to respective database types, enabling efficient information storage, search, reconstruction, retrieval and scalability. Additional aspects are found in the following Detailed Description.

### BRIEF DESCRIPTION OF THE DRAWINGS

FIG. 1 is a comparative illustration of various software system architectures.

FIG. 2 is an illustration of an exemplary High Level FPOS Model Diagram illustrating several key architecture components.

FIG. 3 is an association diagram of an exemplary Object Configuration & Definition using Globally Managed and Locally Deployed NoSQL Data.

FIG. 4 is diagram showing various exemplary FPOS Service Data Objects and their inter-relationships.

FIG. 5 is an illustration of a Private (Instance) Database Ensemble Primary Fragment Identifier.

FIG. 6 illustrates the various Tables and relationships as used within an exemplary FPOS model.

FIG. 7 is a sub-graph illustrating exemplary General Object Relationships.

FIG. 8 is a sub-graph of a Physical Inventory, for mapping between a given set of Locations, Entities, and Containers, etc.

FIG. 9 is a sub-graph showing process definition relationships for the specific purpose of defining processes (sequences of operations).

FIG. 10 is a sub-graph illustrating Graph Data correlating Process Execution.

FIG. 11 is mapping of file sets from Object Storage in an exemplary FPOS implementation.

FIG. 12 is an exemplary Time Series Data to Audits & Events chart.

FIG. 13 is a flow diagram showing the action of creating an entity configuration and an individual entity record of that configuration.

### DETAILED DESCRIPTION

An exemplary Fragmented Persistence Object Services (FPOS) model is described, of a modernized “microservices” approach to distributing the computation “Object” services based upon abstraction of primitive action or object models (e.g., a Location service which manages data about physical spaces where other things can be located such as rooms, states, drawers, shelves). All “Object Services” read details about the objects they manage from a NoSQL database type which can be modified and configured to influence the behavior of each service on specific objects which they manage without new code. Using this configuration database type, each “object” service has the logic programmed within to fragment the information about the specific objects they manage into multiple different database types each optimized for storage, search, reconstruction, and scalability. As an example, Relational databases perform well for storing attributes of an object but perform poorly for managing the relationships that object might have to other objects which are also managed in a software system. Graph databases are optimized for storing and retrieving extensive relationship networks but cannot scale to manage all properties and values of objects. In contrast, object services within FPOS use their configuration to partition information about an object into fragments. Fragments are stored in database types corresponding to the fragment's data characteristics (for example, relationship vs. attribute vs. time-series vs. file, etc.), and not necessarily tied to a “an object type.” This is due to the fact that a single object's data may cross multiple database types, specifically because one object may have heterogeneous fragments, each of which are stored in a database type optimized for storage and retrieval of that information.

The exemplary FPOS model uses a combination of relational database, graph database, object stores, time (and or event) series database and NoSQL databases. This approach provides high throughput, efficiency, flexibility, and scalability.

In its most general form, the exemplary Model is a software design architectural pattern which can manage data for any “thing” or “activity” with exact specification through a highly configurable model so that software applications can be built and operate more efficiently and represent the subject matter of the software with exactness. Many of the features described eliminate repetitive coding processes other prior art database management systems require, once the exemplary architecture is operating.

As described below, the Logical Object Configuration in a non-limiting example uses a NoSQL database type to define Logical Data Types, Logical Relationship Types and Logical System Objects which are highly abstracted to enable any “thing” or “activity” to be described more specifically through more specific definitions using these abstract definitions.

The Object-centric Microservices are microservices which are built with 1 to 1 parity with the Logical System Objects to manage the exchange (storage and retrieval) of data for all derivative entities of those logical objects.

To efficiently and accurately store information which mirrors the physical and conceptual world, a specific pattern is used by the Object-centric Microservices for splitting the data stored for any entity derived from a Logical System Object.

The Data Fragment Transactions are executed by the Object-centric Microservices directly with multiple database types, each one selected for the type of data in each fragment.

The target databases which constitute the Multi-type Data Storage Ensemble are of different types and purposes made specifically for the different data fragments for any object. These databases are shared across all Object-centric Microservices but responsible for a specific fragment of the data used to describe any entity.

Many of the below FIGS. will describe the exemplary FPOS approach utilizing functional diagrams, graphs, trees, etc. However, it is understood that in a commercial or practical implementation, the various processes noted herein can be represented as functional modules, which embody software routines and function-specific algorithms. Also various features described herein, requiring coding or programming skills are understood to be within the skill set of one of ordinary skill. That is, the various features and objectives described herein provide a “map” that teaches one of ordinary skill to develop one or more or all parts of the system(s), processes, method, etc., without undue experimentation.

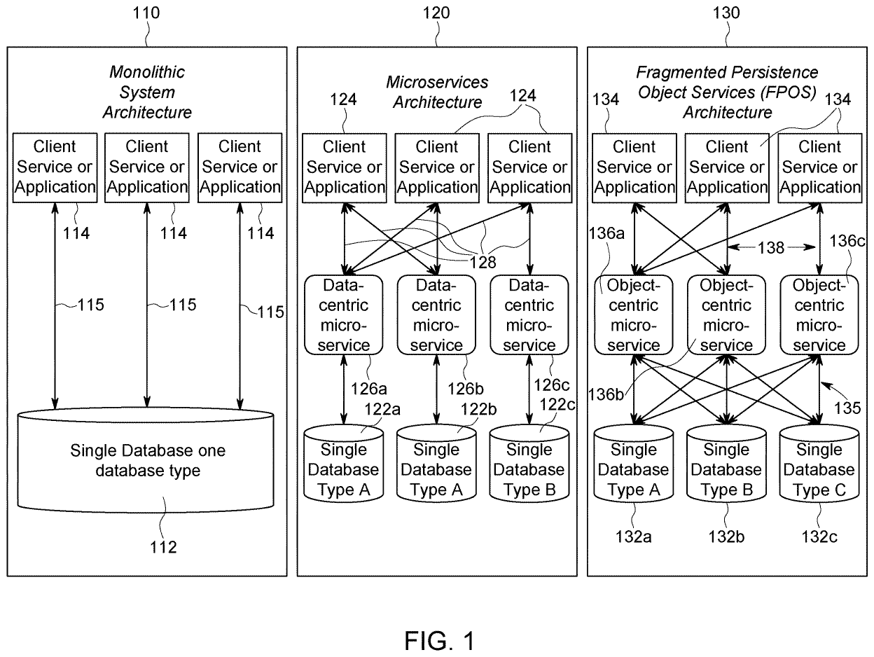

FIG. 1 is a comparative illustration of various software system architectures. Two prior art systems, a Monolithic System Architecture 110 and Microservices Architecture 120 are compared to the exemplary FPOS approach 130. All three systems operate between “server-side” Database sets 112, 122, 132 and the Client Service or Application sets 114, 124, 134. The Monolithic System Architecture data path 115 is seen to be directly between its central Database 112 and multiple Client Service or Applications 114. The Microservices Architecture 120 utilizes one-to-one paths 125 from its Single Database Types 122 to intermediary Data-centric microservices 126a, 126b, 126c. Wherein the Data-centric microservices 126a-c can connect one-to-one or one-to-many Client Service or Applications 124 via pathways 128. It is understood this flexibility in the Microservices Architecture 120 is constrained to the data type being exchanged. Thus, only matching data types between the Databases 122 and their respective Data-centric microservices 126a, 126b, 126c are permissible. Seen for example where the left two Databases 122 are of data type A and their associated pathways are constrained to the left two Data-centric microservices 126a, 126b.

In contrast, the exemplary FPOS approach 130 circumvents the constraints of the Microservices Architecture 120 by utilizing intermediary Object-centric microservices 136a, 136b, 136c, which are agnostic to the data type originating from Databases 132, as indicated by multiple pathways 136. Client Service or Application side 138 pathways may replicate Microservices-like pathways 135, or alternate pathways

Apparent in the FIG., is that the FPOS approach is connected to a client-side and target side database, the “network” being via a wireless or wired medium. Conventionally, such networks are Cloud-based Internet, with compute-servers containing the respective databases and servicing the databases as well, and also for client-side and user-side queries. And as such may constitute one or more of the various pathways described above. Some advantages of an exemplary FPOS implementation as further detailed below are:

Accuracy: The creation of abstract object classes and the configuration of specific objects using abstract data types enables any conceptual or physical thing to be described precisely-including all its relationships and actions performed by or upon the object. No information loss is imposed due to storage in one database type.

Performance: Having multiple databases for each object service enables parallelism and smaller read/write payloads when storing and retrieving data. Additionally, each database type is used in the optimal way for that type; therefore, all read and write operations are as fast as possible throughout the system.

Scalability: The common principle of sharing tasks among multiple microservices to allow parallelism and on-demand scaling of resources is maintained with the array of “object services”, which can be as numerous or few as determined for any given software system requires. Leveraging native cloud architecture facilitates built-in global geographic scaling depending upon the cloud provider chosen.

Flexibility (Build): The services built and included in and FPOS based system design is flexible and therefore support many software development approaches. In addition, the FPOS architecture can be used to support any technology for front end user interface design and development for any type of software market.

Flexibility (Consumer): The configurable nature of all specific objects in the system allows a single software product built using the FPOS architecture to be flexible for the owner and end user of the product.

Extensibility: The database types, service-to-service communication mechanism, and abstract system and data types of the FPOS easily facilitate new technologies we don't know about yet. As an example, the Chan-Zuckerburg Institute is actively pursuing an AI based model of cells as a “data type”. The technology component which is developed for this at some time in the future can be added as an additional database type and the “cell” can be defined or updated to leverage that new way of storing and retrieving biological cell information without creating an entirely new system.

Efficiency: The utilization of data stored within an FPOS system design eliminates the need for data extraction and curation as it includes data access technologies which support data analytics, data visualization, data science, machine learning and artificial intelligence uses without reprocessing and replication.

The Fragmented Persistence Object Services (FPOS) model is designed to provide enhanced capabilities for end user software applications or software services. Information persists in a Findable, Accessible, Interoperable and Reusable (FAIR.org) manner to support software applications which are transactional and those which are used for data analytics. Non-limiting examples of transactional software types include Laboratory Information Systems, Health Information Systems, Asset Management Systems, Enterprise Resource Planning systems, Customer Relationship Management software and many others used for daily work execution. Examples of data analytics uses include Business Intelligence software, bioinformatics analysis pipelines, machine learning applications and artificial intelligence agents.

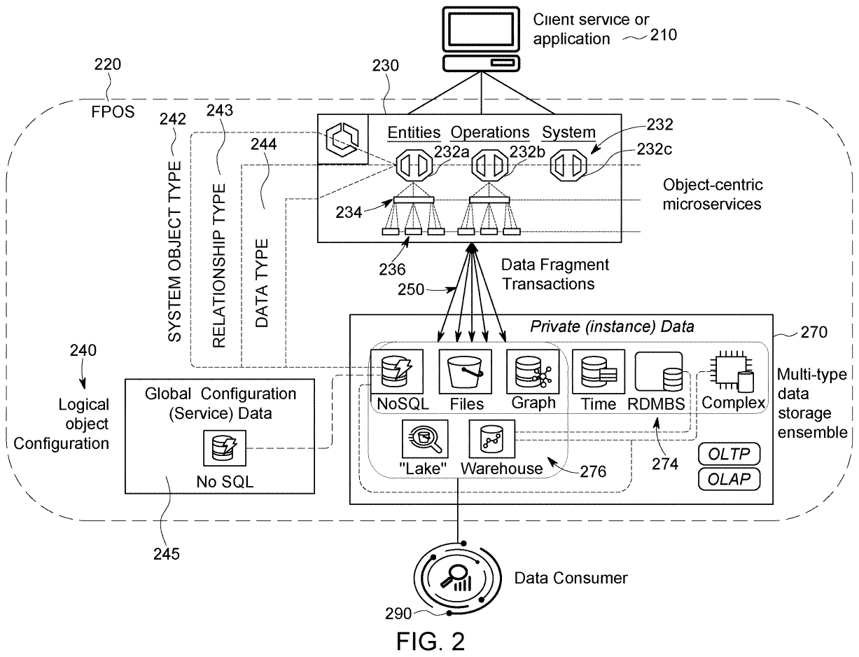

FIG. 2 is an illustration of an exemplary High Level FPOS Model Diagram 220, illustrating several architecture components. The Logical Object Configuration 240, Object-centric Microservices 230, Data Fragment Transactions 250, and Multi-type Data Storage Ensemble 270, etc. work together to create a mechanism to store and retrieve any information in a way which mirrors the way in which humans understand and interpret the physical world-through objects. Data and information exchanged between a Client Service or Application 210 (usually any software application or service requiring persistent data storage) and the target Data Consumer 290 (which can also be any data processing, analytics, or visualization software/application) are facilitated through the architecture of an FPOS Model 220.

The FPOS Model 220 utilizes a Logical Object Configuration 240 to define the logic and behaviors coded into the Object-centric Microservices 230 to perform the Data Fragment Transactions 250 for reading and writing data to and from the Multi-type Data Storage Ensemble 270. Wherein the Object-centric Microservices 230 performs a series of operations in discrete compute containers Logical Object Services (Globally defined) 232 using highly abstracted logic, the Customer specific derived object classes 234 and further derived Customer specific object definitions 236 are included in the persistent data. The Global object services are categorized into 2 or 3 distinct compute service categories, shown here as encompassing Entities 232a, Operations 232b, and System 232c Object services. Moreover, the number and table types may vary without departing from the spirit and scope of this disclosure.

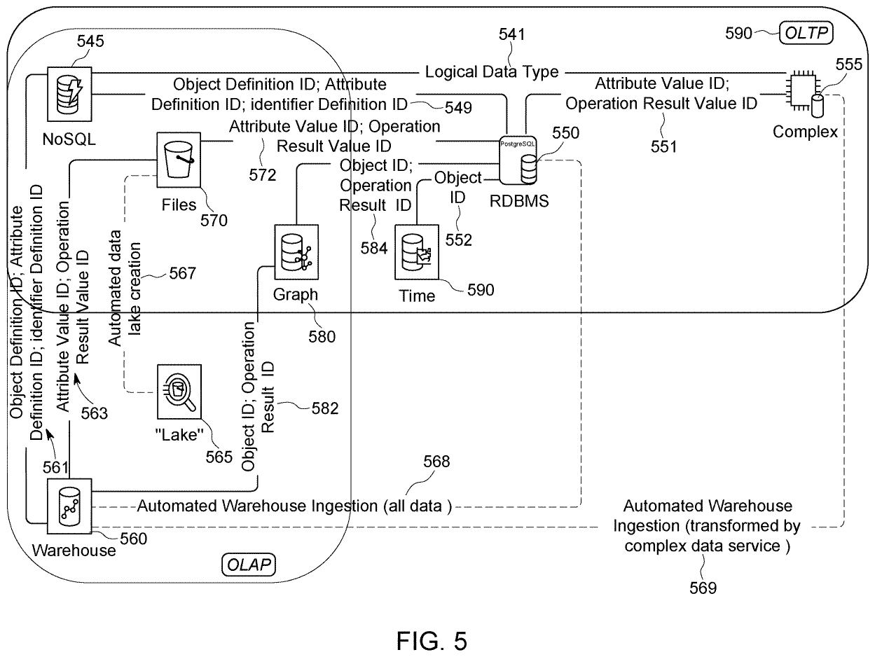

These various tables are created and managed by the developer of the software system(s) using the FPOS model 220 for data persistence. The Global Object Services 232a, 232b, 232c implement the compute side of the Logical Object Configuration 240, inheriting the structure and behavior of LOGICAL SYSTEM OBJECT TYPES 242, LOGICAL RELATIONSHIP TYPES 243 and LOGICAL SYSTEM DATA TYPES 244 used by the Multi-type Data Storage Ensemble 270. These Global configurations are tightly coupled to each new product release (version). Moreover, each release will distribute customer side copies of the Logical Object Configuration by replicating from a shared Global Configuration Service Data 245 repository managed by the software provider responsible for producing new versions. The Global Configuration information can be in stored in various data structures, stores, tables, etc. The Multi-type Data Storage Ensemble 270 facilitates real time transaction data sources OLTP (e.g., OnLine Transaction Processing) and configuration driven automatic data sources for analytics uses OLAP (e.g., OnLine). Data Fragment Transactions 250 are performed through the Object-centric Microservices. The Data Fragment Transactions 250 provide service-specific fragmentation of objects into multiple database types executed as needed, in parallel or serial. Examples of the multiple database types of various object-related types are shown as reference nos. 274 and 276. The Data Fragmentation Transactions 250 is more fully described in FIG. 5.

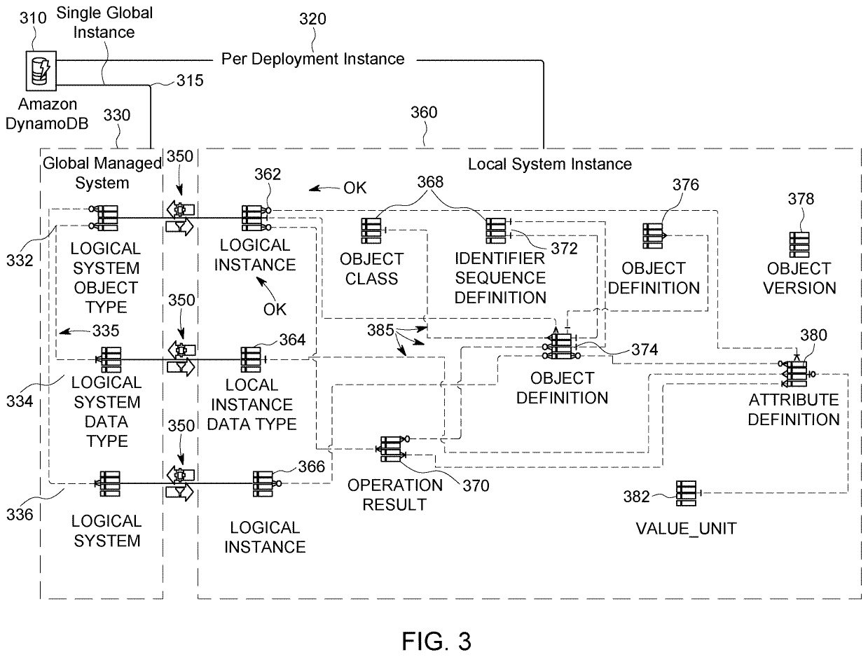

The Global configurations (from the Global Configuration (Service) Data 245) can be managed in a single instance by the system developer but synchronized to each Private instance or deployment of the system. There is no “limit” to the number of Private instances of the software system built using the FPOS model and deployment of the system to specific end users can be connected for automated deployment and updates over the Internet or they can be deployed via disk or drive to an isolated closed environment. The Private object configurations is shown here as having 3 INSTANCE tables (e.g., 242, 243, 244) for configuration of the logical types and an additional 8 tables (see FIG. 3) used to store configurations and history specific to the Private instance of the system.

As demonstrated above, Object-centric microservices 230 can serve as part of the exemplary FPOS model 220. The specific code or development language and compiler used to build and implement Object-centric microservices 230 does not need to be specified as part of the FPOS model 220. The services can be written in any programming language, even different languages for different services. One limitation imposed is that the microservice connect with and directly interact with all the databases and database types necessary to manage the storage and retrieval of data following the logical configurations described previously.

In addition to software development language (code) variety, the protocols or mechanism for communication between services or between the services and the user-facing software application is open. The definitions of the logical objects, in a commercial prototype can use Java Standard Object Notation (JSON) and was used in the examples provided and the current standard in software development is the use of Representational State Transfer (REST) service communications; however, the specific technology used for exchanging data about the objects for which the microservices are responsible for managing may evolve with new technology which improves speed and efficiency. Thus, alternative programming languages and notations and communication approaches may be utilized.

There is no mandate for how many Logical System Objects within the Logical Objects Configuration 240 should be managed by a single Object-centric Microservice 230 as this will depend upon the specific use case of a given software system built using FPOS 220. Considerations including performance, operating cost, user experience are among the factors to consider.

FIG. 3 is an association diagram of an exemplary Object Configuration & Definition using Globally Managed and Locally Deployed NoSQL Data. Note: Technology components in this example are identified using Amazon Web Services (AWS) commercially available components; however, any cloud native NoSQL technology components can be used. In this example the AWS NoSQL database type (DynamoDB) 310 is used for the Single Global Instance 315 in the Global Managed System 330 and for each Per Deployment Instance 320, in this example, a Local System Instance 360. The Global Managed System 330 contains a Logical System Object Type 332, a Logical System Data Type 334, and Logic System Relationship Type 336. The Logical System Object Type 332 contains logical object definitions which are versioned with system (code) version releases, creating a managed highest-order level of abstraction for system logic and behavior which categorizes each object type as an entity 232a or an operation 232b. The Logical System Data Type 334 contains logical data type definitions which are versioned with system (code) releases. This provides a global source of “logical truth” for how all services handle various data within the application. The Logic System Relationship Type 336 contains logical relationship type definitions which are versioned with system (code) released. Although NoSQL databases do not allow direct inter-table relationships, primary identifiers, data/information between the various Logical System Tables 330 are shared 335. Pathways 350 represent data transfers where each environment will retrieve a local instance of all logical system object for the currently running versions of the application from the single global source of truth which is managed by software builder for all microservice and all software release version.

The Local System Instance 360 has analogous Logical Instance Object Type 362, Logical Instance Data Type 364, and Logical Instance Relationship Type 336. The Logical Instance Object Type 362 contains a replica of the version specific subset of records stored in the Logical System Data Type 332 stored in the local environment only. The Logical Instance Data Type 364 contains a replica of all version specific Logical System Data Type 334 stored in the local environment only. Logical Instance Relationship Type 366 contains a replica of all version specific Logical System Relationship Type 336 stored in the local environment This data set stores the records for the application version of this local instance. It is filtered and updated by the application updates for all three logical tables as shown 350.

Additional “tables” (or data structures) are formed in the Local System Instance 360 such as Object Class 368, Operation Result Definition 370, Identifier Sequence Definition 372, Object Definition 374, Object Definition Version 376, Object Version 378, Attribute Definition 380 and Value_Unit 382. Object Class 368 contains object classes impacting navigation and applies organization specific rules to entities and operations which are created. Functionally, their definitions are augmentations of the logical types. Operation Result Definition 370 contains operation result definitions and are implemented and managed by the organizations. Results are sets of attributes which are added to an operation in association with entities (and containers in most cases). Identifier Sequence Definition 372 contains identifier sequence definitions which enable the definition of a unique identifier to be generated as part of a larger template with human meaning, common for naming or barcode generation. Object Definition 374 contains object definitions which are implemented and managed by the organizations. All objects conform to a definition and all definitions get their behavior from system object type and organization specific parameter which are inhered from the object class. Relationships are of a specific relation type and also have a unique label. Object Definition Version 376 contains each change to an object definition, enabling persistence as a new version. Object Version 378 is used when versioning is enabled in an object definition, wherein each object of that definition is recorded for persistence as a new version. Attribute Definition 380 contains attribute definitions, for example for an organization. Objects are defined using an array of attributes. Attributes are extended instances of a data type. Value_Unit 382 represents Base system and organization specific units, which can be assigned to for any attribute or result. A non-limiting example is a conversion between metric and imperial systems, etc. Inter-table primary identifiers shared between tables 385 enable microservices to create references during the data fragmentation and restoration process.

It should be appreciated that the relationships shown between NoSQL tables are not true database relationships as these do not exist in NoSQL databases; however, the Object-centric services used within the FPOS model leverage the depicted relationships 335, 385 between logical types, classes and definitions to fragment and assemble data from the multiple database types for every configured object within any given instance of their software product. The specific use of the NoSQL database type for these configurations and version history is due to the ability for NoSQL database types to store data in any structure rapidly and inexpensively. NoSQL databases perform poorly for writing and reading sub-elements within their records, which is not required for configuration and version management. It should be appreciated that the above example is one possible implementation scenario in the context of an enterprise, e.g., Amazon. Various databases, nomenclatures and interactions may change, depending on the implementation objective(s) of the enterprise. It should be noted that the term “enterprise” is befitting of any commercial, governmental, academic, regulated, or other organization that operates software systems storing information relevant to their organization. In the software and database arts, this term is well understood to encompass any organizations or entities that rely on modern computing/software systems for managing their operations' data.

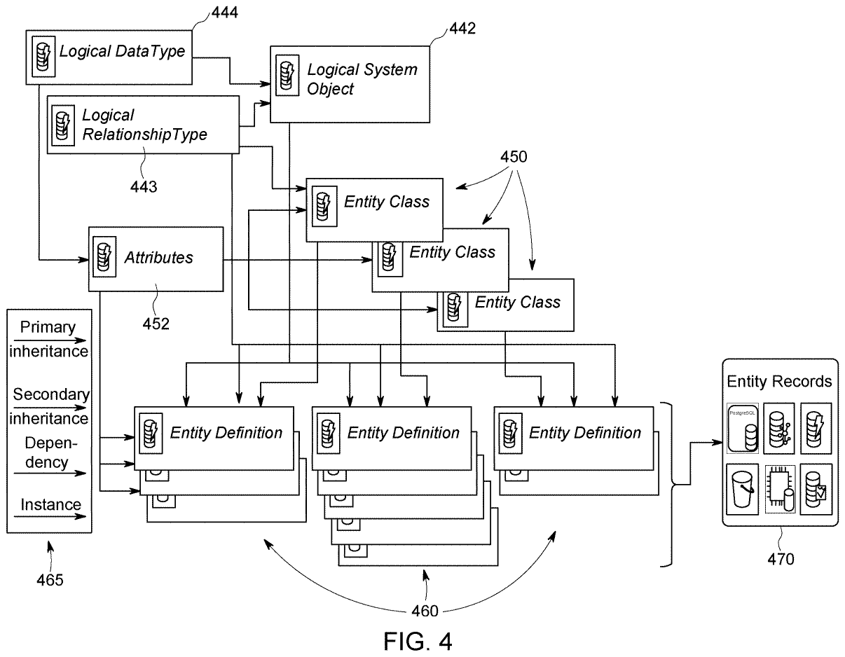

FIG. 4 is diagram showing various exemplary FPOS Service Data Objects and their inter-relationships. Referring to FIGS. 1-4, the flexibility of the FPOS model 230 to store any “thing” or “action” (designated as Entity or Operation in FPOS) relies upon several key data object definitions stored within the global configuration database 245 which can be a NoSQL database(s). The definitions for Logical Data Types 244, Logical Relationship Types 243 and Logical System Objects Type 242 stored locally in the Local System Instance 360 and replicated from the managed global instance (Global Configuration (Service) data 245) are tightly coupled (and a dependency of) all the Object-centric Microservices 230. While other microservices can be integrated with the FPOS architecture, the Object-centric Microservices 230 efficiently facilitate the FPOS architecture as they are coded to properly interpret the highly abstracted logical definitions in order to manage the Create, Read, Update, Delete (CRUD) operations by properly splitting and joining the data fragments used to store those logical objects in the various database types.

Every Logical System Object 442 copied from the global configuration database 245, 330 into the Local System Instance 360 will be tightly coupled with the Object-centric Microservices 230 which use those definitions. The Global records align all application microservices with each unique customer environment. Therefore, an allocation of one microservice per logical system object can be made. A Logical System Object 442 is defined to operate using any number between zero and all Logical Data Types 444 and Logical Relationship Types 443. Object-centric Microservices 230 contain the code to manage the data transactions, including the fragmentation and re-assembly of data records across database types, for all of the Logical Data Types 444 and Logical Relationship Types 443 defined for the Logical System Objects 442 managed by the service.

Each Object-centric Microservice 230 facilitates abstract Logical System Objects 442 (and their data and relationship types) to be used to derive additional levels of object definitions which are purely configuration based for any given Logical System Instance of the FPOS architected software system. Given the prepared logical objects and microservices for abstract, primitive objects no new code is required for the additional, more specific configurations, to be used for any specific instance, use-case, or end-user environment. Each Entity Class 450 has required Attributes 452 and Relationships, where the Attributes are derived from the Logical Data Types 444 and the Relationships implement Logical Relationship Types 443. Entity Classes 450 can be used to implement high level business rules or data ontology which are used to define the objects across an entire instance or deployment (e.g. a customer environment who operates in the transportation industry).

Each Entity Class 450 is derived into Entity Definitions 460. In general, the Entity Records 470 conform to the system object, class and entity definitions; and the Entity Records 470 are stored in a specific fragmentation pattern defined within each object microservice. All The Entity Definitions 460 inherit a Logical System Object 442 as well as the Attributes 452 and Relationships 443 from their parent Entity Class 450; however, they can also define additional Attributes 452 and Relationships (not shown) using the same Logical Data Types 444 and Logical Relationship Types 443. This granularity between Entity Definitions 460 can be accomplished via legend/steps 465, shown here as comprising one or more inheritances (Primary/Secondary/etc.) Dependency(ies) and Instances. This serves to allow more discreet definitions of the objects managed by each microservice for the purpose of configuring more specific ontologies and software application uses for specific functions or use-cases within a business all using the same FPOS modeled software system. For example, an Entity Class 450 for a specific deployment in the transportation industry might be Airplanes but more specific details are Configured for Passenger Planes, Military Defense Planes, Commercial Freight Planes, etc. As with Entity Classes 450, whether inherited from the Class or implemented directly within the Entity Definition, all relationships and definitions are derived from the same Logical System Objects 442, Logical Data Types 444 and Logical Relationship Types 443 and therefore the Object-centric Microservices 230 require no modification to support an application for any configured specific industry or use case.

The primary data exchange occurs by storage and retrieval of discreet instances (Entity Records 470) of the configured Entity Definitions 460 by Object-centric Microservices 230. Entity Definitions 460 provide all identification, attribute and relationship data values for every discreet data object transacted by the Microservice between the user facing application or service and the Multi-type Database Ensemble.

### Data Fragment Transactions

Based upon the Logical System configurations (which are copied from the Global Managed System 330 to each Local System Instance 360) and configurations of the local instance Attributes 452, Entity Classes 450 and Entity Definitions 460 which persist in the NoSQL database instances each specific Entity is fragmented into storage following a pattern which leverages each database type for its optimized purpose following an exemplary pattern as shown in the Table 1 below:

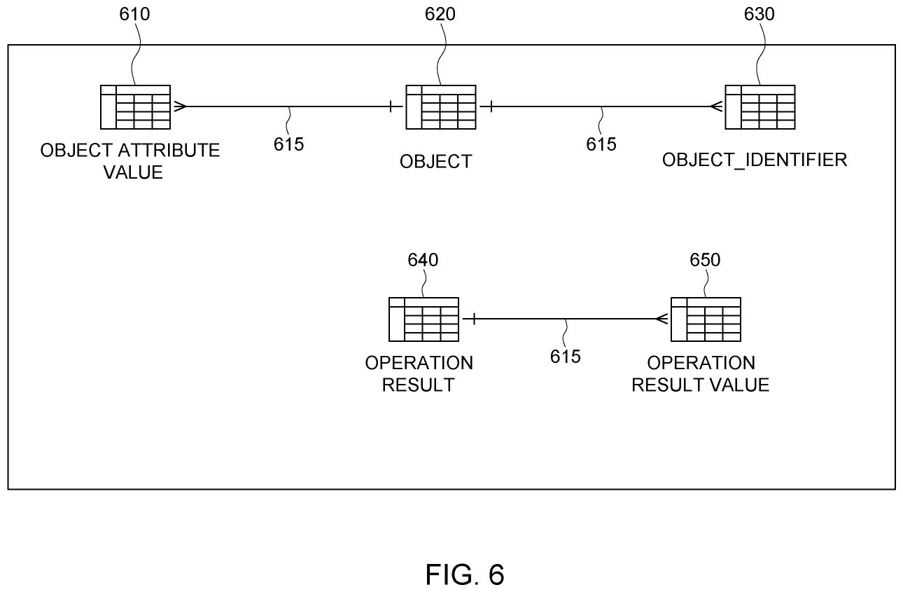

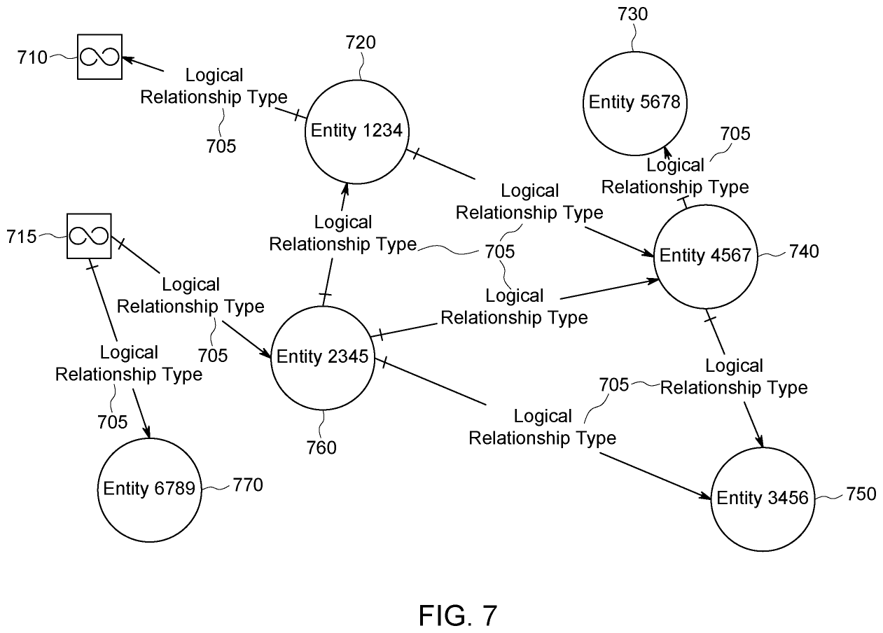

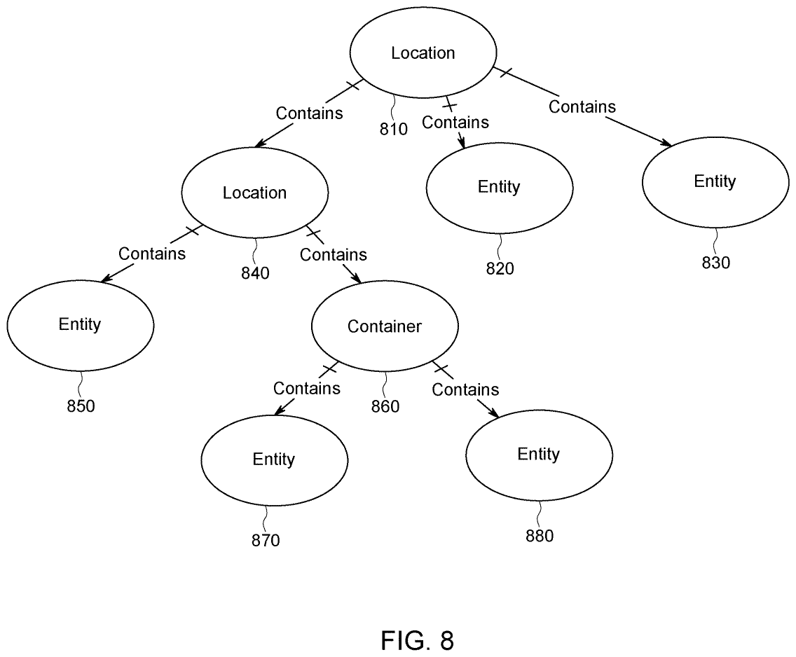

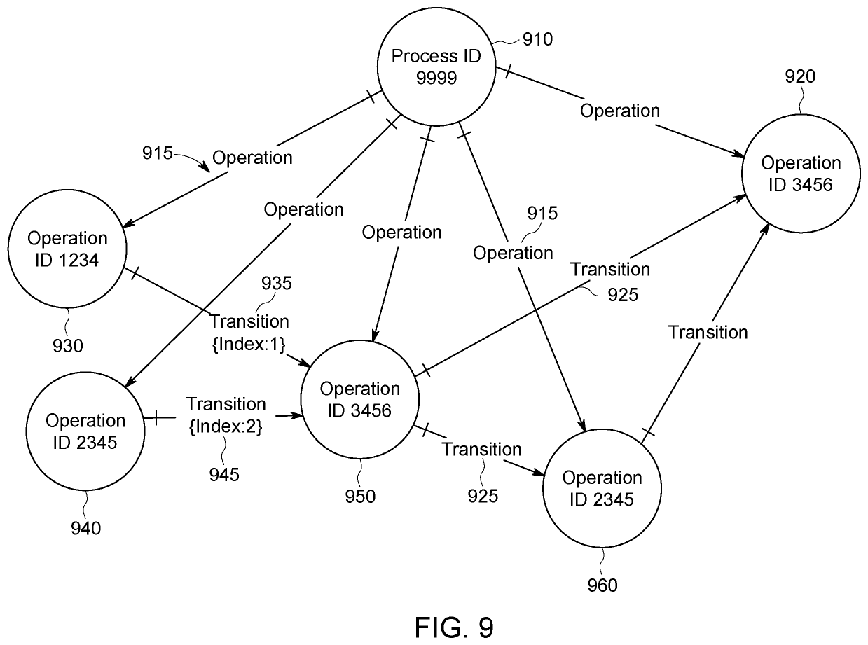

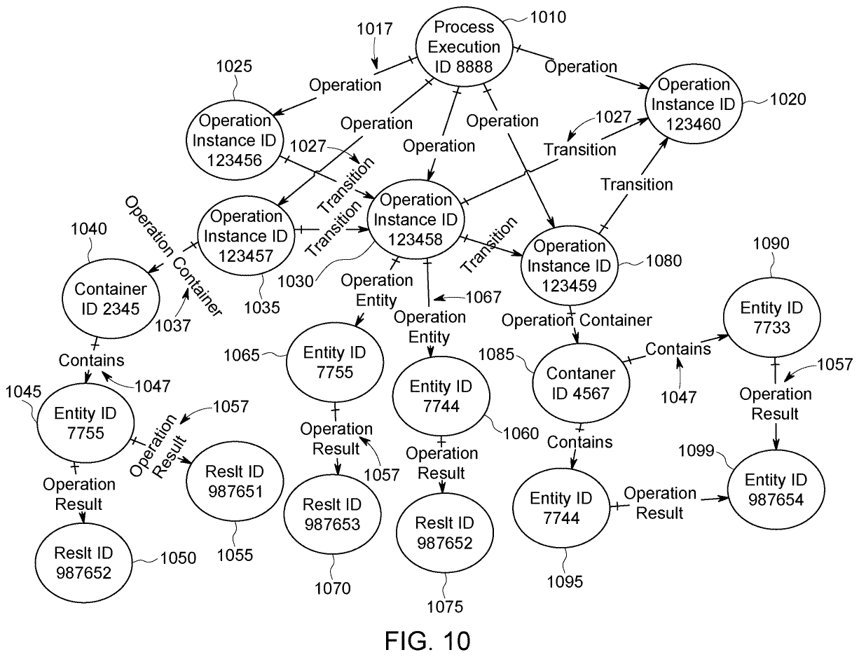

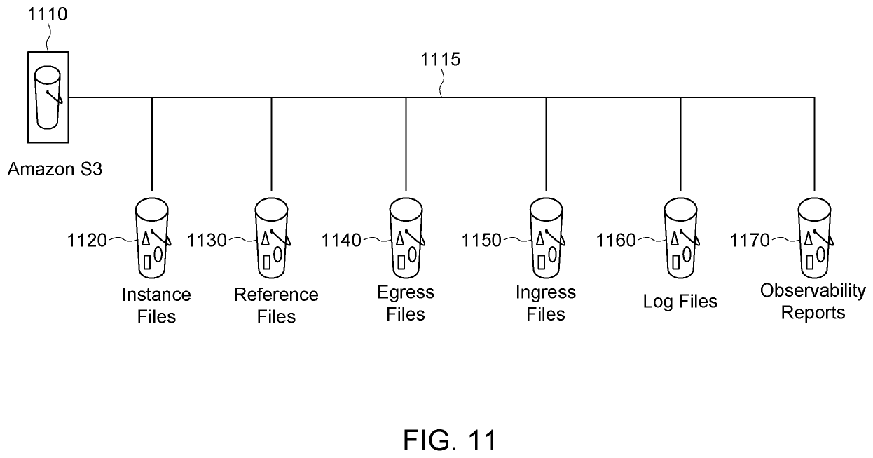

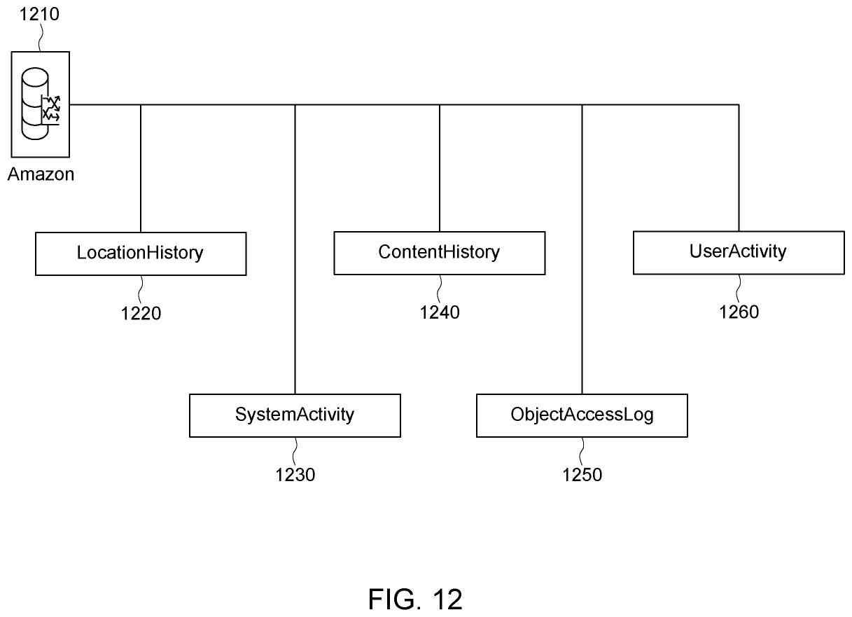

TABLE 1

| Entity Configuration Element | Database Type for Persistent Storage |
|---|---|
| Object Relationships | Graph Database (e.g., FIG. 7) |
| Physical Inventory | Graph Database (e.g., FIG. 8) |
| Process/Workflow Definition | Graph Database (e.g., FIG. 9) |
| Activity/Operation Execution | Graph Database (e.g., FIG. 10) |
| Entity Attribute Values | Relational Database (e.g., FIG. 6) |
| Activity/Operation Result Values | Relational Database (e.g., FIG. 6) |
| History and Logging | Time Series and/or Event Streaming |
| | Database (e.g., FIG. 12) |
| Files/Attachments | Object Storage (e.g., FIG. 11) |
| Unique Entity Identifiers | Relational Database (e.g., FIG. 6) |

In addition to standard types, there may exist additional complex types of data which need to be managed as another fragment of information. These will use a single service paired with a specific data persistence component (one or more databases), which may be simple or extensive depending upon the data being stored. Some examples of these “complex data types” are labeled as EC2 (FIGS. 5-555) as an example of how a service and database might be managed and deployed in AWS. Non-limiting examples are listed in the Table 2 below:

TABLE 2

| Industry/Use Case | | Complex Data Storage |
|---|---|---|
| Example | Special Data Type Example | Example |
| Chemistry | Chemical structures of | Chemistry API Service and |
| | molecules | PostgreSQL Database |
| | | using Chemical Cartridge |
| DNA Testing | DNA sequences | DNA sequence BLAST file |
| | | in object/file storage |
| Geographic Locations | Global Positioning | Geographic Information |
| | coordinates representing | Service (GIS) database |
| | a geographic location | |
| Environmental Biology or | Images annotated with | Pixel map database with |
| Clinical Pathology | markups or shading | coordinate markup references |
| High resolution imagery | Deconstructed high | Pyramid structure image |
| | resolution microscope | segmentation for active |
| | image | zoom level reconstruction |
| Predictive Analytics | Machine Learning | Real time prediction results |
| | Prediction algorithm | from continuous learning |
| | | model |

Complex data types can be implemented like any other database type within the FPOS architecture by simply defining the data type of the relationship or attribute used in the Logical System Object 240 configuration and implementing the code for handling that complex data type for the Object-centric Microservice 230 for that Logical System Object 442. The exemplary FPOS model 130, 220 enables new complex data types, even those not yet conceived of, to be added to software systems using the FPOS model as part of normal software development life cycle (SDLC) processes we know today.

The fragmentation of object data across different databases (of different types) places the burden on the Object-centric Microservices 230 to properly fragment and re-construct data existing in multiple databases. To ensure this occurs reliably and robustly for all Object-centric Microservices, 230 there are specific identifiers within the database schema specific to each database type. Each database will use a different terminology specific to its type for unique identifiers for records; therefore, they are described universally as Fragment Identifiers. Fragment Identifiers exist in multiple databases to ensure that they are all fragments of the same object managed by an Object-centric Microservice.

For example, FIG. 5 is an illustration of a Private (Instance) Database Ensemble Primary Fragment Identifier, utilizing steps in the above description. The Global Configuration (Service) Data is held in the NoSQL database(s) 545 and its resources are used to reference a Logical Data Type ID 547, wherein IDs 549 containing Object Definition ID; Attribute Definition ID; and Identifier Definition ID are procured. In this example, a Complex type 555 is associated with the ID(s). In addition, an Attribute Value ID and Operation Result ID 551 is procured from Relational Database Management System (RDBMS) 550, providing additional information to Complex type 555.

For a dedicated analytics data persistence_location such as a Warehouse 560, NoSQL database 545 and its resources are used to reference a Logical Data Type ID 547, wherein IDs 561 containing Object Definition ID; Attribute Definition ID; and Identifier Definition ID for the Warehouse 560 are procured. Corresponding IDs 563 containing Attribute Value ID and Operation Result Value ID are corresponded with Files 570. Automated Warehouse Ingestion (all data) 568 is corresponded to RDBMS 550.

Additionally, if necessary, Automated Warehouse Ingestion (transformed by Complex data device) 569 is corresponded to Complex type 555. Files 570 also exchange data 572 of Attribute Value ID and Operation Result Value ID with RDBMS 550.

When a dedicated analytics data Lake 565 is provisioned, the Fragment Identifiers already persisted with the Files 570 enable automated data Lake creation 567 without requiring a separate extract-transform-load process. Warehouse 560 is also corresponded to Graph Database 580, via IDs 582 containing Object ID and Operation Result ID. Graph Database 580 also corresponds with RDBMS 550 via IDs 584 containing Object ID and Operation Result ID. A Time Series Database 590 is shown connected to the RDBMS 550 by referencing an Object ID 592 from the RDBMS 550.

Object-centric Microservices are transactional and therefore are responsible for CRUD operations using the fragments which exchange data with the transactional databases 590 (labeled OLTP). The same Fragment Identifiers persist in the analytics (OLAP) data sources, although these exist not for the purposes of the Object-centric Microservices but to enable data analytics services or endpoints to utilize the transactional data.

There is no specific method for connection to any of the specific databases, data sources or complex data type services required when creating the Object-centric Microservices as this should follow software engineering best practices. The FPOS model serves to define a pattern for fragmenting the information about objects into data persistence components, linking them by fragment identifiers necessary for the transactions 547, 549, 551, 572, 584, 592.

There is no defined order or parallelism for transacting with the different databases by the Object-centric Microservices as this will depend upon the context of the data transaction (e.g. writing new records, updating parts of a record, retrieving records with various pieces of information).

### Multi-Type Data Storage Ensemble

There are multiple core database types used within the current implementation of the FPOS model. Of course, more or less core databases may be used, depending on database capabilities and FPOS model objectives. Additional complex data storage can be managed by implementing additional data sources as noted in the Data Fragmentation discussion in FIG. 5.

In the current FPOS model implementation, a NoSQL database type is used for configuration and version history storage because it is optimal for efficient storage and retrieval of complete data objects by a key value and the content can vary widely without impacting performance. The NoSQL cloud native databases available commercially, such as Amazon DynamoDB are fast, secure, resilient and cost effective. The structure and purpose of the NoSQL database types to support the data types, relationship types, attributes, entity classes and entity definitions along with version history of the same was described previously.

In the current FPOS model implementation, the relational database(s) is constructed using a modified Entity-Attribute-Value model to facilitate dynamic configurations of entity identifiers, entity attribute values and operations results without structural modification to the database.

It should be appreciated that a fragment identifier assigned by an Object-centric Microservice during a write operation is capable to persist into both the Multi-type Data Storage Ensemble used for transactional operations and a separate analytics data store, such that an analytics consumer accesses fragmented data using the same fragment identifier without requiring an intermediate extract-to-transform-to-load process. This fragment identifier approach enables more rapid and robust tracking in write operations and storage operations.

FIG. 6 illustrates the various Tables and relationships as used within an exemplary FPOS model, in the context of Relational Data: Object Instances & Results. Various tables store references to the unique attribute, object and result definitions which are used by the Object-centric Microservice to formulate the database transactions using Structured Query Language (SQL) dynamically based upon the definition within the System Object, Entity Class and Entity Definition configurations described previously. The relational database also contains strict foreign keys 615 between tables.

Specifically, Object Attribute Value table 610 is configured to contain all values for all attributes of any object. Empty records are not created because object definitions will maintain places for defined attributes. Deprecated attributes will retain values for their original objects. Object table 620 is configured to store all objects. Every “thing” is an “entity” while every “action” is an operation which describes the action but can have infinite instances (persist in FIG. 10 graph only). Object_Identifier table 630 contains multiple object identifiers which can reference the same object-, it is an Indexed table for fast retrieval of objects by any of the IDs. Operation Result table 640 is configured to contain an array of attributes and values associated with one entity and one operation. Instance details such as container are stored in the graph (FIG. 10). Operation Result Value is configured to contain all values for all attributes of any operation. Empty records are not created because operation definitions will maintain places for defined attributes. Deprecated attributes will retain values for their original operation results.

In an exemplary FPOS implementation, a Graph database type is used to store all entity relationships in a generic manner using the Logical Relationship Types which are configured in the Logical System Objects 442, Entity Classes 450 and Entity Definitions 460. There is no imposed logic or structure for relationships. The simple structure of this graphing approach using the objects/entities and their related entities/objects enables complex querying which traverses many relationships using any graph query language (e.g. Gremlin, openCypher, SPARQL) used by the Object-centric Microservice to perform CRUD operations using the relationships fragment of the object.

FIGS. 7, 8, 9, 10 represent four sub-graphs with an exemplary FPOS implementation. For example, the Graph database types detailed below can also be used to store specific highly relational and recursive relationships including physical inventory, process or workflow definitions, and specific process execution operations (a workflow or process executed one specific time). This captures how to define and store the procedures used act upon things or capture how things are acted upon, noted previously as “actions”. In each FIG., graph database vertices are represented with circles. The content of the circles in each case indicate one unique object with either a representative numeric identifier which would correspond to the identifier in the Relational Data (OBJECT data table (for example, FIG. 6—element 620) or the vertex will list only the LOGICAL INSTANCE OBJECT TYPE (for example, FIG. 3—element 362) from which the entity in the graph vertex must belong.

FIG. 7 is a sub-graph illustrating exemplary General Object Relationships. Graph vertices 720, 730, 740, 750, 760, 770 represent discrete entities. The connecting lines 705 represent some defined relationship type which exists between the discrete entities. Symbols 710, 715 illustrate that the General Object Relationships graph can extend to ANY entity within the system which has a defined relationship to any other entity within the system.

FIG. 8 is a sub-graph of a Physical Inventory, wherein there is a mapping between a given set of Locations, Entities, and Containers, etc. The unique relationship involved in physical inventory “contains” is used to establish a sub-graph which specifically defines the hierarchy of a physical inventory where an entity of the specific logical type “Location” 810 can contain another entity of type “Location” 840 or contain an entity of any other configured type which represents a physical object 820, 830. Similarly, “Location” 840 as shown contains entity 850 of unspecified type but also contains an entity of specific type “Container” 860. An entity of type “Container” 860 also “contains” any other entity type 870, 880.

FIG. 9 is a sub-graph showing process definition relationships for the specific purpose of defining processes (sequences of operations). This graph is made up of entities of Logical System Objects “Process” and “Operation” as the nodes of the graph and those are related by Operation or Transition edges (connectors). From this, a sequence of defined activities can be connected in any process, whether that be a series of calculations, physical activities, logic steps, etc. The details of any “Process” or “Operation” will be configured within any system through the Entity Class and Entity Definitions described as part of system configuration. For example, an entity type of “Process ID 9999” 910 will be related to any number of entities of type “Operation ID . . . ” as shown in 920, 930, 940, 950, 960. That relationship between process and operation is defined using the specific relationship type “Operation” 915. As processes have an ordered flow of those operations, the “Transition” 925 relationships are defined to reflect the order of the “process”. Where an operation 950 is preceded by two operations 930, 940 then the “Transitions” 935, 945 are ordered using a numeric index (1, 2) to eliminate ambiguity.

FIG. 10 is a sub-graph illustrating Process Execution. When a defined process (as exampled in FIG. 9) is executed, a process execution sub-graph is used to capture the relationship between the operations as defined and the specific entities upon which the operation will act and any results generated during that operation on those entities. This utilizes a subset of Logical System Objects and Logical Relationship Types just as the other specific (sub) graphs to capture the operations as well as the specific entities and containers in the state they were in at the time of execution. Additionally, the result IDs link the specific entities which may have some type of result associated with them and that instance of the operation which was performed. Those Result IDs are linked to the results in the relational database during the defragmentation (re-assembly) of data in the Object-centric Microservice. The Result ID for each operation result in the Relational Database described above will be related to the specific operation instance which generated those results using this Process Execution Graph. This relationship is managed by the Object-centric Microservice by maintaining that identifier in both fragments when storing results associated with the Logical Objects it manages and subsequently uses that identifier to reconstruct the results with the object instance following the logic written into the code of the Microservice.

For example, when a previously defined process executes, a new vertex is created 1010 and mapped to the operation instances 1020, 1025, 1030, 1035, 1080 with the same “operation” edges (connectors) 1017 depicted in FIG. 9. The order of execution of all operation instances are mapped with “Transition” edges 1027. Operations performed directly on entities of general types 1065, 1060 are connected to the operation instances 1030 by the “Operation Entity” edge 1067. Operations performed on Container entity types 1040, 1085 are designated using “Operation Container” edges 1037 and the general entities which are “contained” within those containers at the moment when the operation is performed 1045, 1090, 1095 are connected using “Contains” edges 1047 just as they are represented in the Physical Inventory sub-graph (as exampled in FIG. 8). An operation performed on entities directly or while in containers may generate results 1050, 1055, 1070, 1075 including when multiple entities exist in one container and results cannot be distinguished 1099.

FIG. 11 is mapping of file sets from Object Storage in an exemplary FPOS implementation (shown here in an Amazon S3 1110 context). This mapping is offered to illustrate the various file types that may be optimally allocated via a file/data trunk 1115 using a commercial product such as Amazon S3 1110. For example, Instance Files 1120 (typically files for the local instance of the application), Reference Files 1130 (typically files internally created for internal consumption with the services of the platform), Egress Files 1140 (typically files for consumption by an external endpoint, presumably linked to an object record), Ingress Files 1150 (typically files externally intended for consumption by the platform, presumably linked to an object record), Log Files 1160 (typically log files capturing timestream and/or eventstream and Observability Reports 1170 (typically for static on-demand or scheduled report (files) for system, data, user, etc. observability). Some data may be optimally stored in their original file format because they may be very large or of an unconventional type, thus they do not need automatic CRUD transactions, or are transitional for automation and integration with other systems an object store is used (e.g. Amazon S3). A file storage system with a unique access key for any file can be used by storing that access key in the attribute value for the data object with which it is affiliated.

FIG. 12 is an exemplary Time Series Database used to store various types of Audits & Events records (in an Amazon context 1210). This chart illustrates five (5) distinct event types used within the FPOS model, each stored within discrete time series tables. The number of event types may vary, but in the prototype embodiment, the stated five (5) event-type specific tables were found to be sufficient. As these databases are utilized for event monitoring per a chronology-based approach, an alternative approach using databases with an event streaming data lake architecture, in place of a dedicated time series database is possible. Therefore, both a dedicated time series database and an event streaming data lake—are valid implementations of the chronological data storage component within the FPOS architecture.

The example provided FIG. 12 includes core concepts linked to previous core concepts such as location history 1220 (being the physical location of any entity-if configured to have a location—will maintain a persistent history as the entity movements are recorded) and content history 1240 (every change to container contents can be tracked—configuration parameter—historically) to store the history of physical location (where the current state is stored in the Inventory Graph-FIG. 8). Other very common core audit activities for modern software include histories for system activity 1230 (all actions taken without a direct user activity are capture here), user activity 1260 (all actions associated with any userID are capture here), or even object access 1250 (for regulated environment deployment of software, all object record access is retained here) for highly regulated systems. Timeseries databases are optimized for large chronological event history capture and retrieval. They are ideal for near-real time monitoring of events by external services such as machine learning models or user analytics.

As stated above, if an event streaming approach is used (for example data lake), then for purposes of clarity, event streaming data lake components are: Event Ingestion, Stream Processing & Delivery, Persistent Storage, Data Cataloging, and Analytical Query.

When an event streaming data lake implementation is pursued, the object storage is partitioned by Microservice Event Type and stores cataloged Object Types. Each event record uses a key structure of Year/Month/Day/Hour for time-based partitioning. The following Object Types have been defined and deployed, expanding upon the time-based five tables of FIG. 12, as WellContentHistory (formerly ContentHistory 1240—refined to well-plate context for life sciences), UserActivity (same as UserActivity 1260—but expanded with Source field), SystemActivity (same as SystemActivity 1230—but expanded with TriggerType/Details), ObjectAccessEvent (formerly ObjectAccessLog 1250—expanded), and AccessManagement-LogEvent (new-captures access control graph changes for traceability).

The event streaming data lake approach offers certain advantages over a dedicated time series database that may be relevant for specific deployments: cost-effective long-term storage through S3 lifecycle policies (automatic tiering to Infrequent Access and Glacier), Parquet columnar format enabling more efficient analytical queries at scale, and decoupled ingestion from query processing for independent scaling. Conversely, a dedicated time series database may offer simpler configuration and built-in time-windowed query semantics. The exemplary FPOS model accommodates either approach. In view of the above, it should be appreciated that in various embodiments, a chronological storage component associated with a transaction can be implemented as one of: (i) a dedicated time-series database, and (ii) an event-streaming data lake comprising event ingestion, stream processing and delivery, persistent storage, data cataloging, and analytical query stages. One or more elements of which are explicitly described herein or understood to be implicit by one of ordinary skill as within the purview of an exemplary FPOS model implementation.

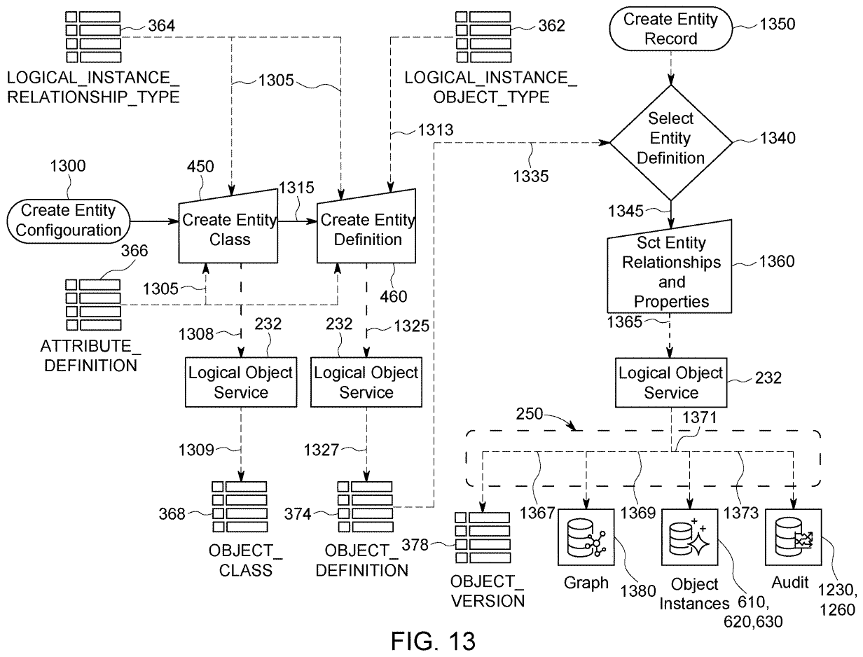

FIG. 13 is a flow diagram showing the action of creating an entity configuration 1300 and creating an individual entity record of that configuration 1350 in any deployed Logical System Instance 360. In a typical client environment, the task of creating a new entity configuration 1300 would be done by the supplier responsible for the deployment or an internal administrator of the client where the instance is deployed. The Entity Configuration flow begins by creating an entity class 450 wherein the participant may elect to add required relationships from the LOGICAL INSTANCE RELATIONSHIP TYPE table 364 illustrated by data flow line 1305 and may also elect to add required attributes from the ATTRIBUTE DEFINITION table 366 illustrated by the data flow line 1306. The interface used by the participant is connected to the Logical Object Service 232 through any number of software interfaces illustrated by line 1308. When complete, the Logical Object Service will store all details of the new Entity Class in the OBJECT CLASS table 368 via database write mechanism 1309. As noted in the FIG. 4 description, the Entity Class serves to add business rules which are passed down to the specific Entity Definitions 460 as part of the Entity Configuration process as indicated by transition1315. The pattern for creating each entity definition 460 enables the participant to apply the relationships and attributes of the Entity Class 450 to the Entity Definition which is based upon exactly one Logical System Object 442 stored in the LOGICAL INSTANCE_OBJECT TYPE table 362 as illustrated by line 1313. The participant may further add relationships from the LOGICAL INSTANCE RELATIONSHIP TYPE table 364 illustrated by data flow line 1305 and may add required attributes from the ATTRIBUTE DEFINITION table 366 illustrated by the data flow line 1306. The interface for creating entity definitions may be the same as 1308 or may be different; therefore, is indicated with a unique interface connector 1325. The mechanism of this interface is not pertinent to this process so long as one exits. When the entity definition is complete, the Logical Object Service 232 will store that entity definition in the OBJECT DEFINITION table 374 using a database write mechanism 1327. The Logical Object Service 232 in FIG. 13 is labeled generically; however, the service will be one service built and deployed specifically to handle all data transactions and user interfaces for the specific Logical System Object selected 1313 in this example flow.

Assuming an Entity Configuration has been created, the flow for any user to create an Entity Record 1350 will begin with selection of an Entity Definition 1340 from those which have been created 1335. The Entity Definition will provide all required or optional entity relationships and properties for the user's selected Entity Definition 1340 as they transition 1345 to an interface to set those relationships and properties 1360. As the Entity Definition selected in 1340 includes the Logical Object Type, the specific Logical Object Service 232 enabling the user interface 1365 and Data Fragment Transactions 250 is the same as the one used for the Entity Definitions. The Logical Object Service 232 will perform all Data Fragment Transactions—in this example the complete historical compressed static record of the new entity record is written 1367 to the OBJECT_VERSION table 378 and relationship data are written 1369 to one or more of the sub-graphs (FIGS. 7, 8, 9, 10) 1380 and the Object Instance data (FIG. 6) is written 1371 to the OBJECT_ATTRIBUTE_VALUE 610, OBJECT 620, OBJECT_IDENTIFIER 630 tables and the event history is written 1373 to the UserActivity 1260 and SystemActivity 1230 tables of the time series database type.

It should be noted that the flow in FIG. 13 exemplifies an “Entity” creation flow to align with FIG. 4 and the concepts of creating a simple “item”. As noted throughout, the same flow for creating an “Operation” applies albeit with some different database tables as endpoints in the Data Fragment Transactions 250. The term “object” in the definition of the tables and microservices is intentional and includes both “entities” and “operations”. It should further be noted that in a reverse flow of this example, where an entity record is read, the same Logical Object Service 232 will read data from the same sources identified using the same Data Fragment Transaction 250 mechanism with database reads in place of writes.

As stated above, various functional elements of the FPOS and related systems may be implemented in software, hardware and/or a combination of the two.

As one of ordinary skill in the art can appreciate, while various aspects and embodiments have been disclosed herein, other aspects and embodiments will be apparent to those skilled in the art. Therefore, various modifications and changes may be made without departing from the spirit and scope of this disclosure. As a non-limiting example, the various software and method approaches are understood to utilize computers, servers, electrical/EM communication capabilities (e.g., Internet, Cell, Wi-fi, Satellite), User Interfaces, memory (non-transitory, for example, RAM, computer code in memory, stored in a local computer or remote “cloud” server or portable device) and the like. All of which and many more not mentioned are standard systems within a database and/or software-based service system. In some implementations, an “app” on a portable device or computer may facilitate the various functions described above.

It is understood that the specific order or hierarchy of steps in the processes disclosed is an example of exemplary approaches. Based upon design preferences, the specific order or hierarchy of steps in the processes may be rearranged while remaining within the scope of the present disclosure.

Those of skill would further appreciate that the various illustrative processes describe above can be represented as functional blocks, modules, circuits, and algorithm steps, and may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical processes, functions, blocks, modules described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, such as a server or cloud network containing servers. Elements of the various exemplary functions described above may be facilitated through portable smart devices and therefore various features may be distributed across different hardware systems.

Accordingly, the various aspects and embodiments disclosed herein are for purposes of illustration and are not intended to be limiting, with the true scope being indicated by the following claims.

What is claimed is:

1. A Fragmented Persistence Object Services (FPOS) system for databases, converting multiple data types into an object-based framework, enabling enhanced data tracking and management, comprising:
a Logical Object Configuration module abstracting different input data types through a Microservice into objects categorized as Logical System Object Type, a Logical Relationship Type and a Logical Data Type, the different data types being input from at least one or more databases, wherein the objects are further categorized into categories of Entity or an Operation; and
a Data Fragmentation module fragmenting the Entity and Operation objects in coordination with a Global Configuration data structure into a Multi-type Data Storage Ensemble containing different database types, enabling the different input data types to be matched to respective database types,
wherein the FPOS system enables optimized storage, search, reconstruction, retrieval, tracking and scalability of the different input data types.

2. The system of claim 1, wherein the Microservice is an Object-centric Microservice and a fragment identifier assigned by the Object-centric Microservice during a write operation for different input data types persists into both the Multi-type Data Storage Ensemble used for transactional operations and a separate analytics data store, such that an analytics consumer accesses fragmented data using the same fragment identifier without an intermediate extract-to-transform-to-load process.

3. The system of claim 2, wherein a chronological storage component associated with a transaction is implemented as one of: (i) a dedicated time-series database, and (ii) an event-streaming data lake comprising event ingestion, stream processing and delivery, persistent storage, data cataloging, and analytical query stages.

4. The system of claim 1, further comprising:
a relational database storing attribute values and operation result values;
graph database storing object relationships;
an object store storing file attachments;
at least one of a time series and event series database storing history and logging information; and
a NoSQL database storing configuration data,
wherein data stored in the various databases are utilized by the Data Fragmentation module to enable efficient data type-to-object-to-database type fragmentation.

5. The system of claim 4, further comprising a plurality of graph databases containing relationships of objects, wherein data about the object is fragmented and is stored in different database types corresponding to at least one of a characteristic of the fragment and to a data type of the fragment.

6. The system of claim 5, further comprising fragmentation identifiers, which map an object for at least one of storage and retrieval, to a matching database type, wherein one or more of the fragmentation identifiers contain an Object Definition ID, an Attribute Definition ID, an Identifier Definition ID, an Attribute Value ID, and a Result Value ID.

7. The system of claim 5, further comprising one or more Object-centric Microservices facilitating the different data types being input and the fragmentation and re-assembly of data records across the different database types, for the objects categorized through the Logical Object Configuration module and a Local System Instance copy of the Global Configuration data structure.

8. The system of claim 1, wherein the Logical System Object Type, the Logical Relationship Type and the Logical Data Type are created in a Local System Instance and contained in a Global Manage System, wherein the Logical System Object Type, the Logical Relationship Type and the Logical Data Type contain type definitions across system version releases.

9. The system of claim 7, wherein a Logical System Object is formed from the Logical Relationship Type and the Logical Data Type, wherein the Entity object includes multiple Entity Classes having defined Attributes and Logical Relationship Types.

10. The system of claim 9, wherein the Attributes are derived from the Logical Data Type and Relationships are obtained from the Logical Relationship Type.

11. The system of claim 10, wherein each Entity Class is formed from the Attributes and Logical Relationship Types.

12. The system of claim 11, further comprising a plurality of database tables containing an Object Class corresponding to object classes impacting navigation and organizational rules, an Operation Result Definition corresponding to operation result definitions, an Identifier Sequence Definition corresponding to identifier sequence definitions enabling at least one of human meaning and barcode generation, an Object Definition corresponding to object definitions implemented and managed by relevant organizations, an Object Definition Version corresponding to changes in an object definition for system version releases persistence, an Object Version corresponding to tracking object changes within system version releases, an Attribute Definition corresponding to object attribute definitions, and a Value_Unit corresponding to equivalences across different measurement units.

13. The system of claim 11, further comprising an Object-centric Microservices managing the Entity Classes.

14. The system of claim 10, wherein a first object identified as a first Entity is related to another object identified as a second Entity via the Relationships.

15. The system of claim 1, wherein the Multi-type Data Storage Ensemble is deployed in a private instance corresponding to an organizational user, and wherein the Logical Object Configuration is replicated from a global configuration store managed by a software provider distinct from the organizational user.

16. A method to process information in a database by converting multiple data types into an object-based framework, enabling enhanced data tracking and management, comprising:
abstracting different data types into objects as a Logical System Object Type, a Logical Relationship Type and a Logical Data Type;
categorizing the objects into compute service categories of an Entity or an Operation;
creating a Local System Instance, wherein a Global Configuration data structure tracks the abstraction results; and
fragmenting the Entity and Operation objects in coordination with the Global Configuration data structure into a Multi-type Data Storage Ensemble containing different database types, wherein the Multi-type Data Storage Ensemble enables the different input data types to be matched to respective database types,
wherein the method enables rapid storage, search, reconstruction, retrieval, tracking and scalability.

17. The method of claim 16, further comprising:
storing attribute information and operation result information in a relational database;
storing object relationships information in a graph database;
storing file attachments information in an object store;
storing history and logging information in at least one of a time series and event series database;
storing configuration information in a NoSQL database; and
fragmenting information on the objects according to the stored information.

18. The method of claim 17, further comprising, assigning relationships between objects via a plurality of graph databases, wherein data about the object is split into fragments, wherein each fragment is stored in a database type corresponding to at least one of a characteristic of the fragment and a data type of the fragment.

19. The method of claim 17, further comprising, inputting data, managing data transactions, fragmentation and re-assembly of data records across different database types via one or more Object-centric Microservices, utilizing the Global Configuration data structure.

20. A data type agnostic, database management method, utilizing abstractions of data to distribute computation object services, comprising:
servicing one or more databases having information of different data types;
reading the information from the one or more databases;
assigning a Location to the information having a physical location;
categorizing the information into objects having a Logical System Object Type, a Logical Relationship Type and a Logical Data Type;
creating a NoSQL database type containing mappings of the read information to the categorized objects, wherein the NoSQL database is modifiable and configurable without requiring new coding instructions to be written; and
fragmenting the information via its object categorization and mapping fragmented information into a Multi-type Data Storage Ensemble containing non-similar database types, wherein the fragmenting and Multi-type Data Storage Ensemble enables efficient information storage, search, reconstruction, retrieval, tracking and scalability.

21. The method of claim 20, further comprising:
storing and retrieving relationships between objects via Graph databases; and
using the Graph databases to split data about the object into fragments, wherein each fragment is stored in the Multi-type Data Storage Ensemble.

22. The method of claim 20, further comprising:
storing information on the objects in a combination of a relational database, graph database, object store, time series or event series databases and NoSQL databases.

23. The method of claim 20, further comprising, communicating information in the one or more databases through an Object-centric Microservices and an institutional user via a Cloud-network.

24. The method of claim 20, further comprising, performing an inheritance hierarchy from a Logical System Object to an Entity Class to an Entity Definition to an Entity Record, wherein the inheritance hierarchy facilitates the no new coding instructions requirement.

25. The method of claim 20, further comprising: forming different versions via a plurality of local instances, wherein a Logical Object Configuration containing the Logical System Object Type, the Logical Relationship Type and the Logical Data Type is replicated from a global configuration to provide a version-coupled configuration according to a global-to-local replication.

26. A non-transitory computer-readable medium storing instructions which, when executed by one or more processors, cause the one or more processors to perform operations, comprising:
abstracting information from different data types into objects as a Logical System Object Type, a Logical Relationship Type and a Logical Data Type;
categorizing the objects into compute service categories of an Entity or an Operation;
creating a Local System Instance, wherein a Global Configuration data structure tracks results of the abstraction; and
fragmenting the Entity and Operation objects in coordination with the Global Configuration data structure into a Multi-type Data Storage Ensemble containing different database types,
wherein the different data types are matched to respective database types, enabling efficient information storage, search, reconstruction, retrieval and scalability.
